(19) United States
(12) Patent Application Publication
(10) Pub. No.: US 2007/0042761 A1
(43) Pub. Date: Feb. 22, 2007

(54) Message inputting device

(75) Inventors: Ching-Ho Tsai, Taipei (TW); Jia-lin Shen, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Delta Electronics, Inc., Taipei (TW)

(21) Appl. No.: 11/397,501

(22) Filed: Apr. 4, 2006

(30) Foreign Application Priority Data
Aug. 17, 2005 (TW) 94128107

(51) Int. Cl. H04Q 7/22; H04L 29/08; H04Q 7/38

(52) U.S. Cl. 455/414.4

(57) ABSTRACT

A message inputting device is provided. The message inputting device includes a template having a blank space for filling so as to produce a message.

### FIELD OF THE INVENTION

The present invention is related to message input, and more particularly, to the method, device, and system of quick message input.

### BACKGROUND OF THE INVENTION

The early mobile phones only had the function of telephone communication, but without word message communication function. With the advanced mobile phone techniques, the mobile phone messages are becoming an essential function. The advantage of the mobile phone messages is that the word message can be saved and sent repeatedly so that the user does not have to repeat his words. It is convenient for the user to communicate with many people for business.

However, the present message inputting method only directly input the spoken language to be the word message of mobile phone. It is very inconvenient for the user to complete a word message only by using the keystrokes on the mobile phone. For example, the present mobile phone only has twelve keystrokes, 0 to 9 plus the symbols “*” and “#”. It means that the user have to use the 12 keystrokes to input all words. For English, the twenty-six letters plus numbers and space are thirty-seven characters. Therefore, every keystroke shares more than three characters in average. So when inputting the message, the user has to select the letters continuously. For example, it is lucky for the user to press the keystroke four times for inputting a four-letter English word; but the user usually needs to press keystroke six to eight times or more for inputting a four-letter English word, which is quite complicated, not to mention the inconvenience for inputting the Chinese words.

To solve the keystroke-pressing problem, some speech recognizing systems have been developed for message inputting that a word or a term is input at a time. In this way, the user still has to select words or terms. Furthermore, because the range of the speech inputting is too large and there exist too many homophones, similar words, and repeated terms, the correctness of the speech recognizing is affected. So the speech recognizing is not necessarily more convenient or saves more time than keystrokes pressing.

Take the Patent No. WO2005031995 for example, messages are input by speech recognizing as a whole. The mentioned method would work only on condition that the words or terms used by the user have to be very close to or completely the same as those preset in the speech recognizing system. In addition, the method needs to setup the variable part of messages in advance. The problem of this method is that the whole sentence has to be recognized correctly for gaining the input message that the user wants. When the sentence structure of the message inputted by the user is not the same as that preset in the mobile phone, this speech recognizing method generates no message. It is not like the word inputting method that even the messages contain faults, the receivers still can understand the meaning of the messages sender through the shape of words, similar spelling or pronunciation. Therefore, this method is not very effective.

Therefore, a quick message inputting device, system, or method is required for the mobile phone message input so as to enable users to complete the message inputting by few simple steps, for example, only inputting few words or terms by keystrokes or speech.

### SUMMARY OF THE INVENTION

To reach the purpose described above, the present invention provides a message inputting device that comprises a template having a blank space for filling so as to produce a message.

Preferably, the message inputting device comprises plural templates to be selected.

Preferably, when one of the plural templates is selected, the message inputting device produces at least a candidate message.

Preferably, the message inputting device further comprises plural blank spaces for filling.

Preferably, when at least one of plural blank spaces are filled, the message inputting device produces at least a candidate message.

Preferably, the blank spaces can be filled by one selected from the group consisting of a word input, a pronunciation input, and a recording input.

Preferably, the pronunciation input has a keyword range for increasing the recognizing success rate.

Preferably, the blank spaces have a plurality of built-in items so that a user can select an item therefrom rather than input an item thereinto.

Preferably, the message inputting device further comprises a plurality of templates and blank spaces, and when one of the templates is selected and one of the blank spaces is filled, the message inputting device produces a message.

To reach the purpose described above, the present invention provides another simple inputting method that comprises steps of (1) providing a template having a field; and (2) filling the field to produce a message.

Preferably, the step (1) further provides a plurality of templates having a plurality of fields.

Preferably, the step (1) is performed at one of the fields.

Preferably, the template has plural fields.

Preferably, in step (2) some of the plural fields are unfilled.

Preferably, in step (2) a plurality of messages are produced.

Preferably, the message inputting method further comprises a step (3): selecting a message from the plurality of messages.

Preferably, the plurality of messages comprise a message of filling in the plural fields continually.

Preferably, the template is a meeting template.

Preferably, the meeting template further comprises a date field; a time field; apposition field; an object field; and a phone number field.

Preferably, the meeting template has a pull-down menu.

Preferably, the meeting template further comprises an item for a message generating.

Preferably, the meeting template further comprises an item for directly sending a message.

Preferably, the meeting template further comprises an item for directly storing a message.

Preferably, the step (3) further comprises a step (4) for selecting either sending or storing the message.

The foregoing and advantage of the present invention will be more clearly understood through the following detailed descriptions with reference to the accompanying drawings, in which:

### BRIEF DESCRIPTION OF THE DRAWINGS

FIG. 1 is a flow chart of a preferred embodiment of the present invention;

FIG. 2 shows the template according to a preferred embodiment of the present invention; and

FIG. 3 is a flow chart of another preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purposes of illustration and description only; it is not intended to be exhaustive or to be limited to the precise form disclosed.

To improve the conventional message inputting device, method or software, the present invention edits messages by filling the fields in the preset template.

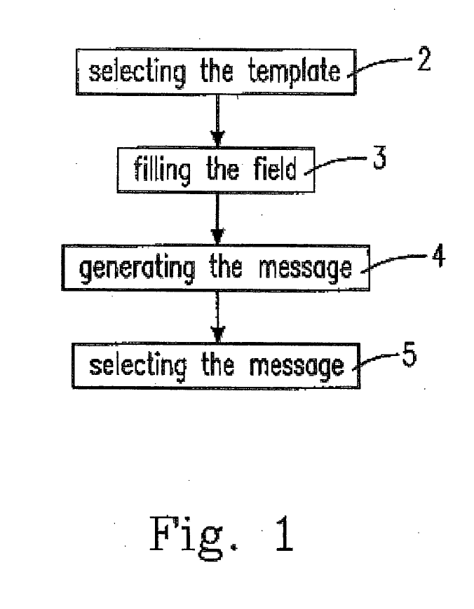

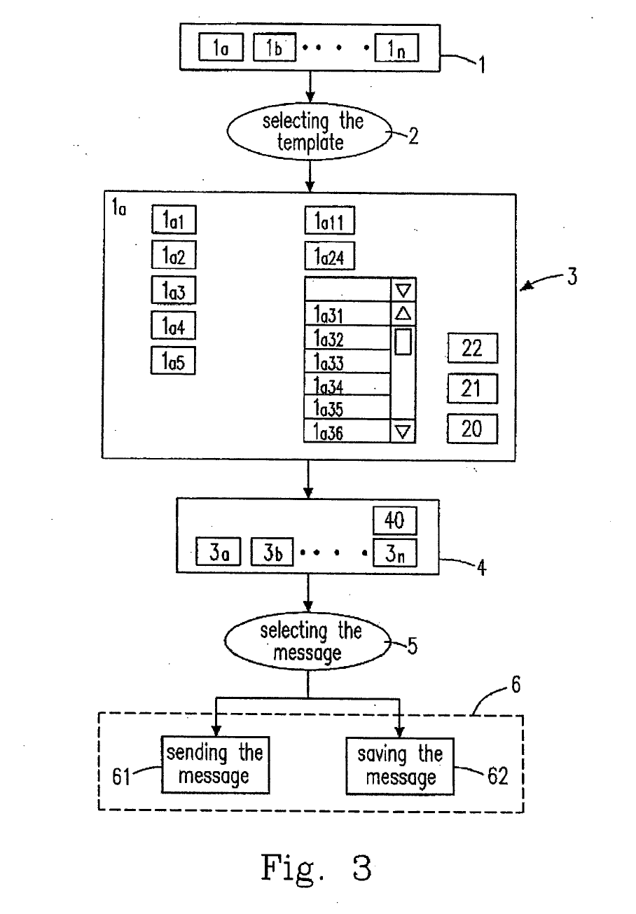

Please refer to FIG. 1, which is a flow chart of a preferred embodiment of the present invention showing the steps of the message inputting method. At step (1), a template is provided. It is illustrated with a single template, so please refer to FIG. 1 and FIG. 3. At step (2), a template 1a is selected. It means that the user selects the first template to be the message mode, sample, or final text for communication. After the template is selected, fields are filled, as shown at step (3). At step (4), messages are generated. Because the fields are filled, the needed information for a message is completed. Until now, the message inputting of the present invention is finished. However, another character of the present invention is that after the fields are filled as shown at step (3), the message inputting device generates at least one message at step (4). If only time field is filled at step (3), the message inputting device can generate at least a message, and the difference of these messages might be in the different positions or the different dates providing the user to choose therefrom. In this way, the user needs not input the position or date fields, which is very convenient to accelerate the message inputting. Furthermore, the present invention can memorize the use states (or habits) of the user. When the message inputting device generates plural messages to be selected at step (4), the message which better matches the information usually inputted by the user will appear at the top for him to select conveniently.

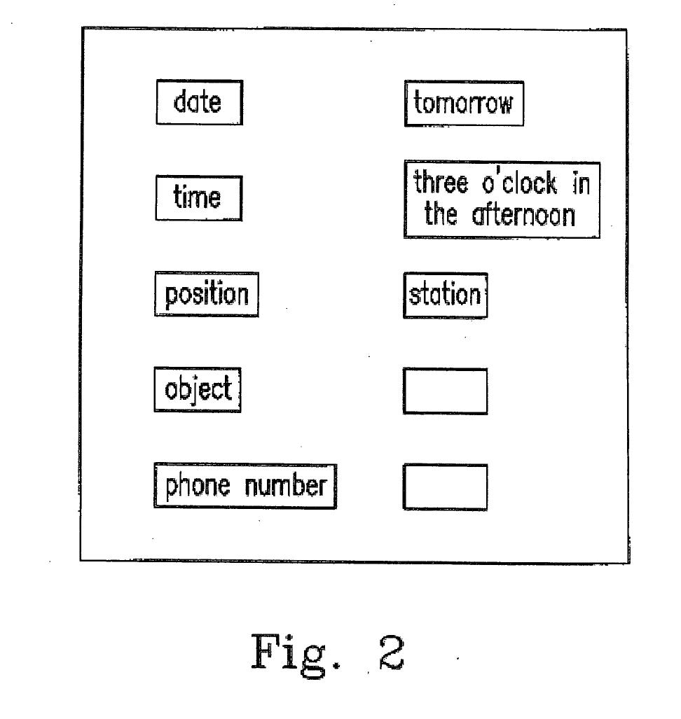

Please refer to FIG. 2, which is the template according to a preferred embodiment of the present invention. As shown in FIG. 2, the meeting template is used to illustrate the usage of the template, because the behavior of meeting comprises the information of objects, events, time, location, and substances that need many fields for completing a message. It means that the message needs lots of information to reach the purpose of the meeting. Therefore, the present invention is illustrated with the example of the meeting. In FIG. 2, the meeting template contains several fields such as the date, time, position, object, and phone number. This shows that in the present invention, the most important information of the message is set as fields. The present invention will generate a message for the user, comprising the sender and receiver, to understand the content clearly only through inputting the appropriate information into the fields.

Please refer to FIG. 2 again, wherein the date field is inputted “tomorrow”, the time field is inputted “three o'clock in the afternoon”, and the position field is filled with “station”, and then the present invention will generate such messages as: (1) I will be at the station at three tomorrow afternoon; (2) I will meet you at the station at three tomorrow afternoon; or (3) it will be started at the station at three tomorrow afternoon. The message style is not limited to the above-mentioned message samples. The messages that are inputted by filling the fields of templates fall into the scope of the present invention, no matter what kinds of language or arrangements they are.

Besides, there is something that should be concerned. The sender and the receiver may usually have a common consensus for the mobile phone messages therebetween. Only part of the information such as the date, time, or location needs to be confirmed. For this reason, the present invention also provides the template having only fields for date, time, or location. The user can select a template for their own need, and needs not concern other fields. Moreover, those fields could be pull-down menus. For examples, the menu of the date field can be selected within thirty days from the current day, or labeled by Monday to Sunday. The menu of the time field can be the twenty-four hours system spaced with each other by one hour. Besides, the menu of the position field can be the station, the usual place, home, the company, etc. Hence, the user only needs to select an appropriate item and carry out it. It is very convenient for the user to make a message without having to key in those fields.

Please refer to FIG. 2 again, wherein the menu of the object field will first choose the members of the phonebook that is built-in in the mobile phone or the personal digital assistant. When the object is selected, the phone number of the selected person will be shown in the phone number field. If the selected person has more than one phone number, the user needs to select one, several, or even all of the phone numbers for sending the message.

Moreover, the fields described above can also be filled using the speech inputting, through which the speech is converted to words. The keywords are preset for increasing the successful rate of the speech recognizing. The speech can of course bypass the speech recognizing and directly recorded as a speech message.

Please refer to FIG. 3, which is a flow chart of another preferred embodiment of the present invention. As shown in FIG. 3, at least one template is provided at step (1). In this embodiment, the present invention provides several kinds of templates to be selected, comprising template 1a, template 1b to template 1n. The user is able to select the appropriate template, as shown at step (2). At step (2), a template is selected, which means the user decides which template is the message model, sample, or final text for communication. The behavior of meeting comprises the information of objects, events, time, location, and substances that need many fields for completing a message. It means that the message needs lots of information to reach the purpose of the meeting. Hence, the meeting template is still used for illustration in FIG. 3. When the template is selected, the fields are filled, as shown at step (3). In the meeting template 1a, there are five fields, which respectively are the date 1a1, time 1a2, location 1a3, object 1a4, and phone number 1a5. If coordinately referring to FIG. 2 for illustration, the date field 1a1 is filled with “tomorrow”, the time field is filled with “three o'clock in the afternoon”, and the location field is shown by a pull-down menu, such as the position_1 1a31, the position_2 1a32, the position_3 1a3, the position_4 1a4, the position_5 1a5, and the position_6 1a6, etc. Actually the position_1 could be the station, the position_2 could be the usual place, the position_3 could be home, the position_4 could be the company, the position_5 could be a hotel name, and the position_6 could be the room number. It is very convenient and efficient for the user by using the pull-down menu, through which he can easily select the desired position without inputting words one by one as the conventional message inputting method. When the user selects a position like the station, the template 1a is shown as FIG. 2. If the selected one is not the station, the field of the position in FIG. 2 will be changed to other positions described above, such as home, the company, and the hotel name, etc.

Please refer to FIG. 3 again, when the date, time, and location are decided, it is time to fill the object field 1a4 and the phone number field 1a5 (please refer to FIG. 2 also). These two fields are also pull-down menus, whose formats are similar to the last paragraph. When the object field 1a4 and the phone number field 1a5 are selected, it is time to decide whether to send the message or not.

For the template 1a in FIG. 3, there are several items such as immediately sending message 20, generating message 21, and saving message 22. Usually, when the object field 1a4 and the phone number field 1a5 are not filled, there are only the generating message 21 and the saving message 22 for selection.

Following the last paragraph, if the generating message item is selected, step (4) is performed; the present invention produces at least one message. As shown in FIG. 3, the present invention produces the message 3a, the message 3b to the message 3n. As described above, the information filled at step (3) is the key to create the arranged combination, i.e. a variety of sentences. Simultaneously at step (4), the message inputting device provides an item for continuously filling with the item 40. The message inputting device of the present invention also has the function of message producing according the fields being filled with step by step. When a message is automatically generated, for example, after the date field 1a1 is filled, the present invention will produce more than a message for the user to select therefrom. If the user wants to select one therefrom, then the step (5) is performed. If the user wants to keep filling the fields, then the step (3) is performed.

If the message auto-generating function is shot down, the user needs to select the message generating 21 manually. In conclusion, no matter what step the user is at, he always can use the message generating 21 function.

When the user fills the object field 1a4, if the device that uses the present invention, such as the phone book of the mobile phone, has the phone number of the object, the present invention can auto-generate the object's phone number in the phone number field. If the object has more than a phone number, the user can select one, partial, or all of the phone numbers therefrom. Of course, the user can fill the phone number field 1a5 manually. Until now, after the user inputs at least a phone number, he can select the immediately sending message 20, generating message 21, or saving message 22. If the user selects the immediately sending message 20, the present invention will send the message. If the user selects the generating message 21, the procedure will go to step (4), generating message 4, and then the user selects the message at step (5). The user selects a message from the message 3a to the message 3n according to his preference, habit, or attempt. Subsequently at step (6), the message is performed, through which the user decides to send the message (step 61) or save the message (step 62).

In conclusion, the feature of the present invention is to edit messages via filling fields by means of the keystroke-input or the speech input. The user only needs to input the key words, and then the sentence-making function of the present invention can finish the complete message. The present invention can generate more than a message for the user's selection with a set of key words.

Besides, the present invention provides more than a template. The user can select the appropriate template according to actual needs and finish the message sending through filling the fields in the templates. Furthermore, the key words, the fields, of the present invention are preset by the pull-down menu, which provides many items for selection. If there is no appropriate item, the user can still fill in the fields manually. Moreover, the present invention also has the learning ability that can remember how many times the key word has been used and shows the mostly-used one at the top of the pull-down menu for convenient selection when the user is inputting.

As above, it is proven that the present invention simplifies the message editing by selecting templates and filling fields. It is very convenient that the user only needs to select the template and fill the fields rather than input words one by one as the prior art. Even the fields are filled by the speech inputting, the correctness of the present invention is much better than the whole sentence recognizing method in the prior art. The user can use the recording method to input the partial recording into the fields as the key words. The user can even use the multimedia, such as the video recording, to show the message so as to increase variety of the content of the sending message for making the receiver understand it easily.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present application which is defined by the appended claims.

What is claimed is:

1. A message inputting device, comprising:
a template having a blank space for filling so as to produce a message.

2. A message inputting device according to claim 1, wherein said message inputting device further comprises a plurality of templates to be selected.

3. A message inputting device according to claim 2, when one of said plurality of templates is selected, said message inputting device producing at least a candidate message.

4. A message inputting device according to claim 1, wherein said message inputting device further comprises a plurality of blank spaces.

5. A message inputting device according to claim 4, when at least one of said plurality of blank spaces are filled, said message inputting device producing at least a candidate message.

6. A message inputting device according to claim 1, wherein said blank space can be filled by one selected from the group consisting of a word input, a pronunciation input, and a recording input.

7. A message inputting device according to claim 6, wherein said pronunciation input has a keyword range for increasing a successful recognizing rate.

8. A message inputting device according to claim 1, wherein said blank space has a plurality of built-in items so that a user select an item therefrom rather than input an item thereinto.

9. A message inputting device according to claim 1, wherein said message inputting device further comprises a plurality of templates and blank spaces, and when one of said templates is selected and one of said blank space is filled, said message inputting device produces a message.

10. A message inputting method, comprising steps of:
(1) providing a template having a field; and
(2) filling in said field to produce a message.

11. A message inputting method according to claim 10, wherein said step (1) further provides a plurality of templates having a plurality of fields.

12. A message inputting method according to claim 10, wherein said step (1) is performed at one of said fields.

13. A message inputting device according to claim 10, wherein said template has plural fields.

14. A message inputting method according to claim 12, wherein, in said step (2) some of said plural fields are unfilled.

15. A message inputting method according to claim 10, wherein, in said step (2) a plurality of messages are produced.

16. A message inputting method according to claim 14, further comprising a step (3): selecting a message from said plurality of messages.

17. A message inputting method according to claim 14, wherein said plurality of messages comprise a message of filling in said plural fields continually.

18. A message inputting method according to claim 10, wherein said template is a meeting template.

19. A message inputting method according to claim 17, wherein said meeting template further comprises:
a date space;
a time space;
a location space;
an object space; and
a phone number space.

20. A message inputting method according to claim 18, wherein said meeting template has a pull-down menu.

21. A message inputting method according to claim 18, wherein said meeting template further comprises an item for a message generating.

22. A message inputting method according to claim 18, wherein said meeting template further comprises an item for directly sending a message.

23. A message inputting method according to claim 18, wherein said meeting template further comprises an item for storing a message.
